(19) United States
(12) Patent Application Publication
(10) Pub. No.: US 2018/0329190 A1
(43) Pub. Date: Nov. 15, 2018

(54) Multi-Stop Illuminator for Video Inspection System with Stepped Aperture Settings

(71) Applicant: Quality Vision International, Inc., Rochester, NY (US)

(72) Inventor: Stephanie M. Bloch, Penfield, NY (US)

(21) Appl. No.: 15/594,065

(22) Filed: May 12, 2017

(51) Int. Cl. G02B 21/06; G01N 21/88

(52) U.S. Cl. CPC G02B 21/06; G01N 21/8806; G01N 2201/062; G01N 2201/06153; G01N 2021/8835

(57) ABSTRACT

An optical inspection system for capturing images of backlit test objects on a detector at two or more aperture settings includes a telecentric imaging system having a first setting associated with a first size aperture stop and a second setting associated with a second larger size aperture stop. An illumination system includes a substage illuminator incorporating (a) a first set of one or more light sources surrounded by a first barrier that defines a first size aperture stop of the illumination system and (b) a second set of one or more light sources located beyond the first barrier and surrounded by a second barrier that defines a second larger size aperture stop of the illumination system. The first size aperture stop of the illumination system images to the first size aperture stop of the telecentric imaging system at the first setting and the second larger size aperture stop of the illumination system images to the second larger size aperture stop of the telecentric imaging system at the second setting.

### TECHNICAL FIELD

This invention relates to illuminators for optical inspection systems, particularly such illuminators that provide for backlighting objects intended for inspection at different magnifications or other settings.

### BACKGROUND OF THE INVENTION

One way in which optical inspection systems gather metrological data from test objects is by illuminating the objects from one direction and imaging the objects from the opposite direction. Such illumination schemes are typically referred to as “backlighting” such that the objects themselves appear dark to the imaging systems and the remaining background appears light. Thus, the objects appear in silhouette, and the points of transition between light and dark allow for the identification of object profiles where light that surrounds or passes through the test objects is contrasted with adjacent portions of the view at which the light is blocked.

Typically, the vision systems of such optical inspection systems image the test object silhouettes through telecentric imaging systems to reduce the effects of changes in magnification with working distance. Telecentric imaging is especially important for imaging silhouettes where the edges of objects are located at different heights or boundary surfaces extend in depth. However, variations in the uniformity of illumination through the object field as well as shape and reflectivity characteristics of the test objects can influence the appearance of the light-to-dark transitions being observed. For example, directional lighting can cast shadows over edges and diffuse surfaces can scatter light over the edges. Even though the imaging system is telecentric, imbalances within the angular radiance distributions collected from the object points can undermine the desired telecentric behavior of the imaging system.

Matching the aperture stop of the illuminator to the aperture stop of the telecentric imaging system allows the telecentric imaging system to operate at its intended numerical aperture while still limiting the range of angles through which the object is illuminated. Higher angles associated with overfilled imaging system apertures can still enter the imaging system aperture by specular or diffuse reflections from the test object, which can obscure the boundaries of the object silhouette. For example, the so-called “wall effect” occurs when off-axis rays from the vertical sides of the test object enter the imaging system aperture. The so-called “wrap-around effect” occurs when off-axis rays from curved or inclined surfaces within the test object profile enter the imaging system aperture. Thus, while a certain range of angles must be collected by the telecentric lens to image the silhouette boundaries with an intended resolution, the range of illumination angles is limited to avoid unnecessarily illuminating the test object from different directions.

The imaging systems of such optical inspection systems are often required to operate at multiple magnifications. The lowest magnifications provide both the largest field of view and the largest depth of field. The highest magnifications provide the highest accuracy and resolution, which is especially needed when edges or other features would otherwise occupy too little image area and too few pixels in the detector. With appropriate calibrations, the lower magnification images can be used to interrelate the smaller fields of higher magnification images.

Commonly owned U.S. Pat. No. 6,488,398 discloses a substage illuminator of an optical measuring system with an adjustable iris located between a light source and a collimating lens for filling without overfilling the aperture of an imaging system capable of collecting backlit images of test objects over a range of different magnifications. Such adjustable irises include a number of moving parts and often require software to control the size of the illuminator aperture. The moving parts and controls add complexity and are subject to wear, which can degrade performance and require expensive repairs or replacements.

### SUMMARY OF THE INVENTION

An optical inspection system for more reliably capturing images of backlit test objects on a detector includes a telecentric imaging system having a first setting associated with a first size aperture stop and a second setting associated with a second larger size aperture stop. Often, the two different settings are associated with two different magnifications for capturing more equal amounts of light at the two magnifications. A mounting stage provides for supporting a test object. An illumination system includes a substage illuminator and a collimating lens for directing light generated by the substage illuminator through the mounting stage to the telecentric imaging system along a common optical axis with the telecentric imaging system. The substage illuminator incorporates (a) a first set of one or more light sources surrounded by a first barrier that extends in height along the optical axis and defines a first size aperture stop of the illumination system and (b) a second set of one or more light sources located beyond the first barrier and surrounded by a second barrier that extends in height along the optical axis and defines a second larger size aperture stop of the illumination system. In addition, the illumination system is related to the telecentric imaging system so that the first size aperture stop of the illumination system images to the first size aperture stop of the telecentric imaging system at the first setting and the second larger size aperture stop of the illumination system images to the second larger size aperture stop of the telecentric imaging system at the second setting.

Preferably, the first and second size aperture stops of the illumination system are located proximate to a back focal plane of the collimating lens. The first setting of the telecentric imaging system is preferably associated with a first front-end lens for directing light collected from the illumination system over a first range of angles through the first size aperture stop, and the setting of the telecentric imaging system is preferably associated with a second front-end lens for directing light collected from the illumination system over a second larger range of angles through the second larger size aperture stop. The first front-end lens of the telecentric imaging system together with the collimating lens of the illumination system is preferably arranged for imaging the first size aperture stop of the illumination system to the first size aperture stop of the telecentric imaging system at the first setting, and the second front-end lens of the telecentric imaging system together with the collimating lens of the illumination system is arranged for imaging the second larger size aperture stop of the illumination system to the second larger size aperture stop of the telecentric imaging system at the second setting.

The first set of one or more light sources can be arranged to provide for illuminating a first homogenizer segment within the first size aperture stop of the illumination system, and the second set of one or more light sources can be arranged to provide for illuminating a second homogenizer segment within the second larger size aperture stop of the illumination system. The first barrier can take the form of a hollow cylindrical column, and the second barrier can take the form of a cylindrical collar. The second set of one or more light sources can be located between the hollow cylindrical column and the cylindrical collar. The first homogenizer segment can have a circular shape and is preferably located within the hollow cylindrical column, and the second homogenizer segment can have an annular shape and is preferably located between the hollow cylindrical column and the cylindrical collar. Preferably, the telecentric imaging system includes a first lens grouping for imaging the test object at the first setting and also preferably includes a second lens grouping for imaging the test object at the second setting.

The telecentric imaging system can also have a third setting associated with a third yet larger size aperture stop of the telecentric imaging system. The substage illuminator can have a third set of one or more light sources surrounded by a third barrier that extends in height along the optical axis and defines a third yet larger size aperture stop of the illumination system. The illumination system can be further related to the telecentric imaging system so that the third yet larger size aperture stop of the illumination system images to the third yet larger size aperture stop of the telecentric imaging system at the third setting.

The substage illuminator as described in one or more embodiments is precisely matched to an imaging system that collects backlit images of test objects at a plurality of discrete settings. A plurality of light sources can be surrounded by concentric barriers that extend in height from proximate to the light sources to a diffuser or other homogenizer located in a common aperture plane of the substage illuminator. The light sources within and between the concentric barriers can be separately energized for emitting light on command. One or more light sources within the innermost concentric barrier preferably illuminate a circular spot on the diffuser having a diameter corresponding to the diameter of the innermost barrier at the diffuser. Between the innermost barrier and an immediately surrounding barrier, one or more light sources preferably contribute to illuminating an annular area on the diffuser having inner and outer diameters corresponding respectively to the diameters of the innermost and immediately surrounding barriers at the diffuser.

Both the one or more light sources within the innermost barrier and the one or more light sources between the innermost barrier and the immediately surrounding barrier can be energized together to illuminate a circular spot on the diffuser having a diameter corresponding to the diameter of the surrounding barrier at the diffuser. While the innermost barrier blocks light from the one or more light sources within the innermost barrier from illuminating the diffuser at a diameter beyond the diameter of the innermost barrier, the innermost barrier does not prevent the illumination of a larger circular spot when both the one or more light sources within the innermost barrier and the one or more light sources between the innermost barrier and the immediately surrounding barrier are energized together. The innermost barrier can be illuminated from both sides to create the circular spot on the diffuser having a diameter corresponding to the diameter of the immediately surrounding barrier at the diffuser.

The circular spot on the diffuser having a diameter corresponding to the diameter of the innermost barrier sets the size of a first illuminator aperture stop, which is preferably matched to the size of a first aperture stop of the imaging system for substantially filling without overfilling the first imaging system aperture at a level that compromises desired measurement accuracy or reliability. The circular spot on the diffuser having a diameter corresponding to the diameter of the immediately surrounding barrier sets the size of a second illuminator aperture stop that is similarly matched in size to a second larger aperture stop of the imaging system. Additional light sources and concentric barriers of progressively larger diameters can be added for illuminating surrounding annular areas, and in conjunction with the light sources within the smaller diameter concentric barriers, the light sources within the additional concentric barriers can illuminate circular areas of the diffuser at progressively larger aperture stop sizes matching the sizes of the larger aperture stops of the imaging system.

Preferably, the number and location of the light sources, including the distance between the light sources and the diffuser, which relates to divergence of the light sources, is chosen to evenly illuminate the diffuser within the intended illuminator aperture stop. Preferably, the diffuser is located in the front focal plane of collimating lens so that each different radial and azimuthal position on the diffuser collimates at a unique angle to the optical axis of the collimating lens over an area corresponding to the range of angles scattered by the diffuser and collected by the collimating lens.

The range of angles through which light from the diffuser is collimated is controlled by the aperture stop size at the diffuser in accordance with the diameter of the outermost barrier subject to internal illumination. Preferably, the ranges of angles set by the two or more different aperture stop sizes at the diffuser correspond to the different ranges of angles through which the imaging system is capable of collecting light at its different size aperture stops.

In a backlit optical inspection system having an imaging system capable of being operated at different discrete settings, an object to be inspected is preferably positioned on a mounting stage that is located between the imaging system and the illumination system. Preferably, the imaging system is a telecentric imaging system that images a silhouette of the object onto a detector. In addition, a front lens of the imaging system in cooperation with the collimating lens of the substage illuminator preferably images the aperture stop of the substage illuminator at the diffuser onto an aperture stop of the imaging system. At each of two or more discrete settings of the imaging system, the numerical aperture of the imaging system changes in association with a change in the size of the aperture stops of the imaging system. Instead of attempting to adjust the size of the illuminator aperture stop through a continuum of positions to match the change in size of the imaging system aperture stop, selected light sources of the substage illuminator can be energized to make a matching discrete change in the size of the illuminator aperture stop without physically moving any parts of the illuminator aperture stop. For example, the one or more light sources within the innermost barrier can be energized to emit light, while the one or more light sources beyond the innermost barrier remain unpowered so as not to emit light, to match the size of the aperture stop of the illuminator to the size of the aperture stop of the imaging system, which might be associated for example with a low magnification of the imaging system. An increase in the size of the aperture stop of the imaging system, which might be associated for example with a higher magnification of the imaging system, only requires the energizing of one or more additional light sources within the immediately surrounding barrier of the substage illuminator to match the size of the illuminator aperture stop to the increased size of the imaging system aperture stop. Additional concentric barriers and containing separately energizable light sources can be added to the substage illuminator to match larger increases in the aperture stop sizes of the imaging system, which might for example be associated with even higher magnifications.

The change in the illuminator aperture size is intended to change the range of angles through which the object field is illuminated rather than the size of the illuminated field. Thus, by appropriately moving the mounting stage, any portion or position of the object illuminated for imaging at low magnification could also be imaged at higher magnification. While fewer rays from individual points on the diffuser enter the imaging system aperture at a higher magnification, the rays from more points on the diffuser can enter the imaging system aperture at the higher magnification for collecting more similar amounts of light at the different magnifications.

### BRIEF DESCRIPTION OF THE DRAWING FIGURES

FIG. 1 is a diagram of an optical inspection system with an illumination system for backlighting a test object and an imaging system arranged for capturing the silhouette of the backlit test object at three different settings of the imaging system.

FIG. 2 is a diagram of the imaging system showing the configuration of ray bundles between an object point on the test object and an image point on an image sensor of a camera at the three different settings.

FIG. 3 is a diagram of the illumination system including a cutaway view of a substage illuminator arranged for use with the three settings of the imaging system.

FIG. 4 is a perspective front view of the substage illuminator of FIG. 3 with diffuser segments removed to show internal structures.

FIG. 5 is a perspective back view of the substage illuminator of FIG. 3.

FIG. 6 is a perspective front view of the substage illuminator of FIG. 3 with the diffuser segments in place.

FIG. 7 is a cutaway view of another illumination system with a substage illuminator arranged for use with two different settings of the imaging system.

FIG. 8 is a cutaway perspective view of the substage illuminator of FIG. 7.

### DETAILED DESCRIPTION OF THE INVENTION

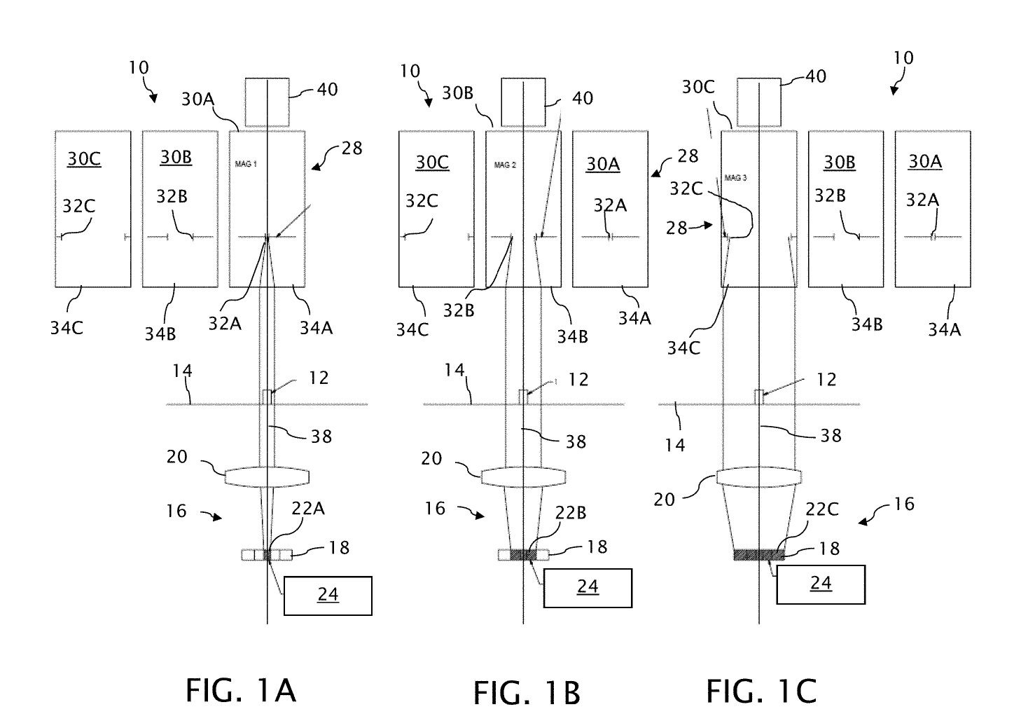

The optical inspection system 10 depicted in FIGS. 1A through 1C is presented in schematic layouts featuring three different settings, which might be associated for example with three different magnifications of the imaging system. In all three settings, the optical inspection system 10 includes the same components adjusted to the different settings. A test object 12 on a mounting stage 14 is backlit by an illumination system 16 that includes a substage illuminator 18 and a collimating lens 20. To convey light past the test object 12, at least a portion of the mounting stage 14 is made of a transparent optical material or otherwise provides for the transmission of light (e.g., such as a wire frame). The substage illuminator 18 is divided into concentric segments that can be separately energized under control of a processor/controller 24 to adjust the effective size of an illuminator aperture stop that is located in the front focal plane of the collimating lens 20. The three different patterns of darkened segments within the substage illuminator 18 represent three different size aperture stops 22A, 22B, and 22C. The light passing through each point within the illuminator aperture stop 22A, 22B, or 22C is collimated by the collimating lens 20 as a uniquely oriented beam converging toward the mounting stage 14. As the sizes of the aperture stops 22A, 22B, and 22C incrementally increase as shown in FIGS. 1A through 1C, the range of angles through which the collimated beams approach the mounting stage 14 is similarly incrementally increased, representing corresponding incremental increases in the numerical aperture of the illumination system 16.

An imaging system 28 includes three different telecentric lens groupings 30A, 30B, and 30C, which might be associated with progressively higher power magnification. The different groupings can be associated with different lenses or different lens positions, such as might be associated with a zoom lens. The three lens groupings 30A, 30B, and 30C are respectively associated with three different size aperture stops 32A, 32B, and 32C, which limit the range of angles that can be collected by front-end lenses 34A, 34B, and 34C of the respective lens groupings 30A, 30B, and 30C. These different angular ranges, which incrementally increase from the smallest aperture stop 32A to the largest aperture stop 32C, represent corresponding discrete increases in the numerical aperture of the imaging system 28.

At the setting of FIG. 1A, the lens grouping 30A is aligned along a common optical axis 38 with both the illumination system 16 and a camera 40 for capturing silhouette images of the test object 12 that is backlit by the illumination system 16. At an opposite conjugate, the front-end lens 34A together with the collimating lens 20 images the aperture stop 22A of the illumination system 16, onto the aperture stop 32A of the imaging system. The size of the imaged aperture stop 22A is matched to the size of the aperture stop 32A so that the numerical aperture of the illumination system 16 is matched to the numerical aperture of the imaging system 28. Thus, points on the test object 12 are illuminated through a range of angles that can be captured by the aperture stop 32A without overfilling the aperture stop 32A in a way that would undesirably reduce the accuracy or reliability of measurement. The higher angular range of illumination angles associated with an overfilled aperture might still enter the aperture stop 32A after deflecting into a lower angle from some part of the test object 12 that is not part of its silhouette in the direction of the common optical axis 38. Underfilling the aperture stop 32A is similarly avoided to preserve the desired resolution of the silhouette without capturing a higher range of angles within the aperture stop 32A beyond those emitted from the illumination system 16.

At the setting of FIG. 1B, the lens grouping 30B is aligned along the common optical axis 38 with both the illumination system 16 and the camera 40. Both the size of the aperture stop 32B and the related the numerical aperture of the lens grouping 30B are larger than the aperture stop 32A and related numerical aperture of lens grouping 30A. In response, the size of the aperture stop 22B of the illumination system 16 is similarly increased in size so that the aperture stop 22B, as imaged by the front-end lens 34B together with the collimating lens 20 onto the aperture stop 32B of the imaging system 28, is matched to the size of the aperture stop 32B. Thus, the numerical aperture of the illumination system 16 is increased to match the larger numerical aperture of the imaging system 28 employing the lens grouping 30B. Although the silhouette of the test object 12 is collected from a wider range of off-axis angles, the depth of field reduces as an inverse function with increases in numerical aperture, which limits opportunities for stray deflections from the test object 12 to enter the aperture stop 32B.

At the setting of FIG. 1C, the lens grouping 30C is aligned along the common optical axis 38 with both the illumination system 16 and the camera 40. Both the size of the aperture stop 32C and the related the numerical aperture of the lens grouping 30C are larger than the aperture stop 32B and related numerical aperture of lens grouping 30B. In response, the size of the aperture stop 22C of the illumination system 16 is similarly increased in size so that the aperture stop 22C, as imaged by the front-end lens 34C together with the collimating lens 20 onto the aperture stop 32C of the imaging system 28, is matched to the size of the aperture stop 32C. Thus, the numerical aperture of the illumination system 16 is increased to match the larger numerical aperture of the imaging system 28 employing the lens grouping 30C. Again, although the silhouette of the test object 12 is collected from a yet wider range of off-axis angles, the depth of field further reduces as an inverse function with increases in numerical aperture, which limits opportunities for stray deflections from the test object 12 to enter the aperture stop 32C.

Although progressively wider beams are drawn in FIGS. 1A through 1C from the collimating lens 20 to the front-end lenses 34A through 34C, the beam widths should not be regarded as field dimensions and are used only to depict the progressively larger numerical apertures of both the illumination and imaging systems 16 and 28. Unless other changes are made, the actual fields of view captured by the imaging system tend to reduce with increases in magnification. Light from illuminated points beyond the field of view generally does not enter the imaging systems aperture stops 32A, 32B, or 32C.

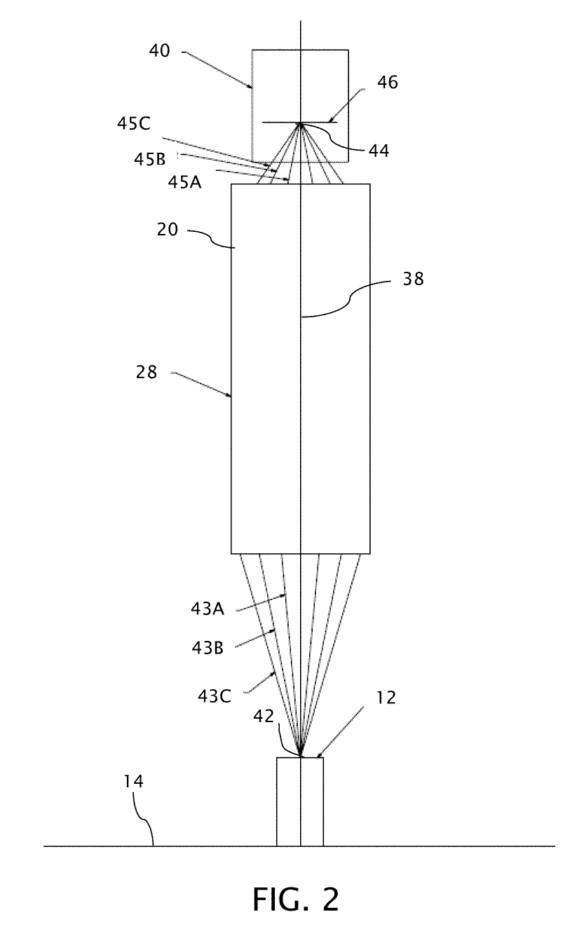

FIG. 2 depicts a composite schematic view of the imaging system 28 conveying light from an object point 42 on the test object 12 to an image point 44 on an image sensor plane 46 of the camera 40. The object point 42 is chosen as a matter of convenience as being located along the common optical axis 38 for revealing characteristics of the imaging system 28 but would not be among the points actually illuminated by the backlighting illumination system 28. The innermost diverging ray bundle 43A collected from the object point 42 through the smallest size numerical aperture reaches the image point 44 through a converging ray bundle 45A. The middle diverging ray bundle 43B collected from the object point 42 through a medium sized numerical aperture reaches the image point 44 through a converging ray bundle 45B. The outermost diverging ray bundle 43C collected from the object point 42 through the largest size numerical aperture reaches the image point 44 through a converging ray bundle 45C. Since the imaging system 28 is intended to remain telecentric at least on its object side at all three settings, the central rays of the ray bundles 43A through 43C from off-axis object points within the respective fields of view remain parallel to the optical axis 38. These central rays also pass through the centers of the aperture stops 32A through 32C. The central rays of the ray bundles 45A through 45C converging to off-axis image points within the image sensor plane 46 also remain parallel to the optical axis 38, where image side telecentricity is also required.

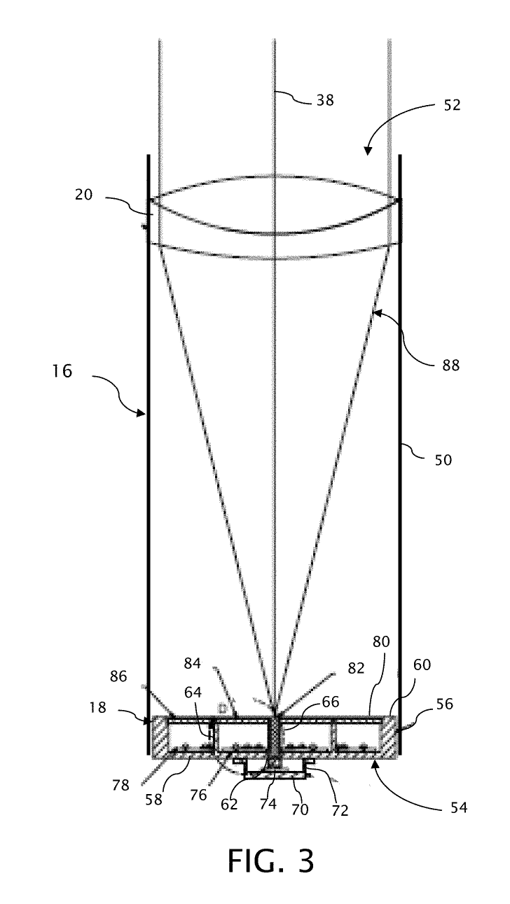

FIG. 3 depicts the illumination system 16 with a more detailed cutaway view of the substage illuminator 18 that can be used to backlight the test object 12, whose resulting silhouette can be captured by the imaging system 16 at three different settings. The illumination system 16 includes a tubular housing 50 that supports both the collimating lens 20 near at an open end 52 and the substage illuminator 18 at an opposite end 54.

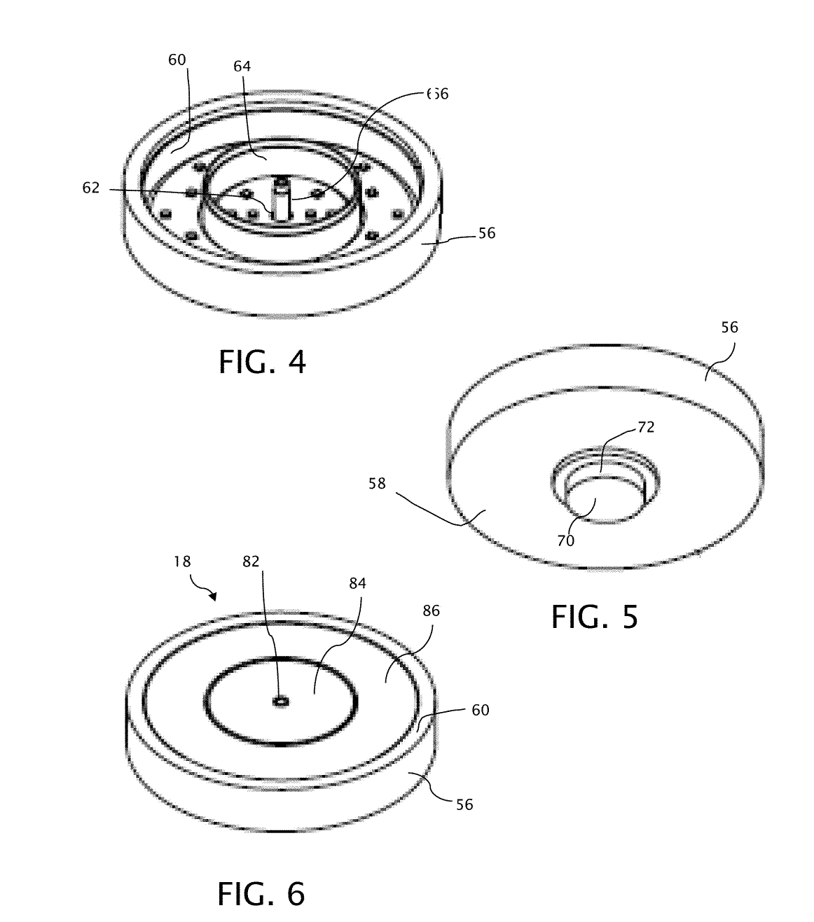

The substage illuminator 18, as also shown in the perspective views of FIGS. 4 through 6, includes a generally disc-shaped housing 56 having a base 58, an upright cylindrical sleeve 60 that fits within the tubular housing 50 of the illumination system 16, a central opening 62 through the base 58, and a cylindrical collar 64 located concentrically between the central opening 62 and the upright cylindrical sleeve 60. A hollow cylindrical column 66 projects through the opening 62 and above the base 58 at a central location. An endcap 70 with a surrounding rim 72 is attached to a bottom of the base 58 further enlarging the hollow space that extends through the hollow cylindrical column 66. A high-powered LED (light emitting diode) forming what is referred to herein as a first set of high-powered LEDs 74 is mounted on the endcap 70 in alignment with the hollow space through the hollow cylindrical column 66. A second set of high-powered LEDs 76 is mounted on the base 58 between the hollow cylindrical column 66 and the cylindrical collar 64 in positions evenly spaced around the hollow cylindrical column 66. A third set of high-powered LEDs 78 is mounted on the base 58 between the cylindrical collar 64 and the upright cylindrical sleeve 60 in positions evenly spaced around the cylindrical collar 64.

The hollow cylindrical column 66, the cylindrical collar 64, and the upright cylindrical sleeve 60 all extend approximately the same distance above the base 58 and include at their top ends recessed seats for supporting concentric diffuser segments, including a circular diffuser segment 82 and two annular diffuser segments 84 and 86, which are shown in FIGS. 3 and 6. The circular diffuser segment 82 rests on a seat formed in the inner circumference of the hollow cylindrical column 66. The annular diffuser segment 84 rests on seats formed in the outer circumference of the hollow cylindrical column 66 and the inner circumference of the cylindrical collar 64. The annular diffuser segment 86 rests on seats formed in the outer circumference of the cylindrical collar 64 and the inner circumference of the upright cylindrical sleeve 60.

The hollow cylindrical column 66 forms in innermost barrier for confining light emitted from the first set of LEDs 74 within a cylindrical light pipe for illuminating the circular diffuser segment 82 and defining the outer reaches of the smallest aperture stop 22A of the illumination system 16. The cylindrical collar 64 forms an immediately surrounding barrier that confines light emitted from the second set of LEDs 76 within an annular space between the cylindrical collar 64 and the hollow cylindrical column 66 for illuminating the annular diffuser segment 84 and defining the outer reaches of the midsize aperture stop 22B of the illumination system 16. The upright cylindrical sleeve 60 forms a further surrounding barrier that confines light emitted from the third set of LEDs 78 within an annular space between the upright cylindrical sleeve 60 and the cylindrical collar 64 for illuminating the annular diffuser segment 86 and defining the outer reaches of the largest aperture stop 22C of the illumination system.

Any one of the first, second, or third sets of high-powered LEDs 74, 76, or 78 can be separately energized under the control of the processor/controller 24 for illuminating any one of the three diffuser segments 82, 84, or 86 or can be energized in any combination for illuminating any two or more of the diffuser segments 82, 84, or 86. Energizing just the first set of high-power LEDs 74 fills the smallest aperture stop 22A of the illumination system 16 with light. Energizing just the first and second sets of high-powered LEDs 74 and 76 fills the midsize aperture stop 22B of the illumination system 16 with light. Energizing all three of the first, second, and third sets of high-powered LEDs 74, 76, and 78 fills the largest aperture stop 22C of the illumination system 16 with light.

The number, light divergence profiles, and placement patterns of the LEDs within first, second, or third sets of high-powered LEDs 74, 76, and 78, as well as their spacing from their respective diffuser segments 82, 84, and 86 are preferably chosen to uniformly illuminate the diffuser segments 82, 84, and 86.

Returning to FIG. 3, the diffuser segments 82, 84, and 86 are preferably located in a common diffuser plane 80, which is positioned at the front focal plane 90 of the collimating lens 20. Individual points on each of the diffuser segments 82, 84, and 86 preferably refract or diffract light through diverging range of angles comprising a diverging beam, such as the diverging beam 88, which fills a substantial portion of the aperture of the collimating lens 20. From there, the light from each point on the diffuser segments 82, 84, and 86 is refracted by the collimating lens 20 as a collimated beam such as the collimated beam 90, having a width capable of filling the intended field of view above the mounting stage 14 and a unique angular orientation to the optical axis 38 in accordance with the radial and azimuthal positions of the point in the diffuser plane 80. The three different size aperture stops 22A, 228, and 22C supported by the substage illuminator 18 can provide for illuminating the test object 12 through three different angular ranges and can be conjugately matched in size to the sizes of the aperture stops 32A, 32B, and 32C of the imaging system 16 at three different settings.

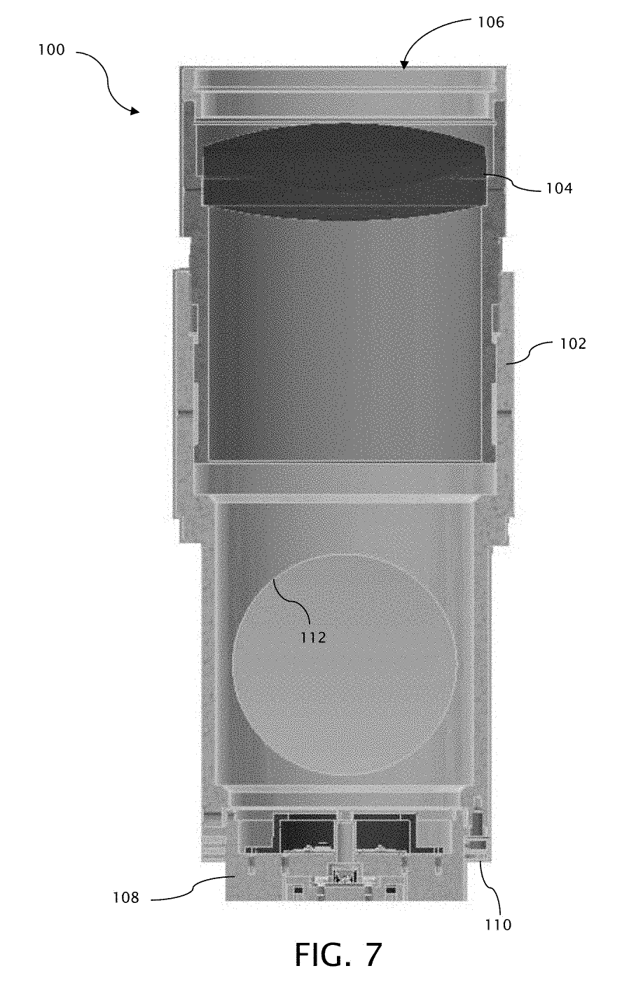

FIG. 7 depicts a cutaway view, an illumination system 100 that can be used to backlight a test object, whose resulting silhouette can be captured by an imaging system similar to the imaging system of the preceding figures but with one less setting. The illumination system 100 includes a tubular housing 102 that supports a collimating lens 104 near at an open end 106 and a substage illuminator 108 at an opposite end 110. A side opening 112 in the housing 102 provides access to the substage illuminator 108.

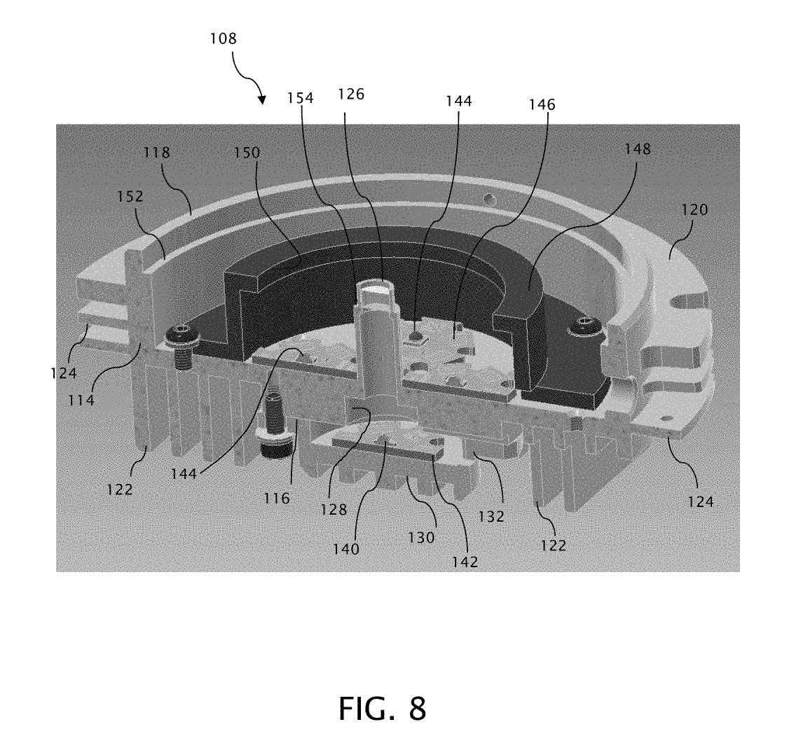

The relatively enlarged view of FIG. 8 shows the substage illuminator 108 in greater detail. A generally disc-shaped housing 114 includes a base 116, an upright sleeve 118 that fits within the tubular housing 102, and a surrounding flange 120 that is bolted to the opposite end 110 of the tubular housing 102. Cylindrical fins 122 project from a bottom of the base 116 and annular fins 124 project from a circumference of the base 116 below the flange 120, both for dissipating heat from the substage illuminator 108. In addition, a hollow cylindrical column 126 projects above the base 116 at a central location. The hollow space within the cylindrical column 126 extends into a countersunk hole 128 that is formed through the base 116. An endcap 130 with a surrounding rim 132 is bolted to the base 116 further enlarging the hollow space that extends through the cylindrical column 126 and the base 116. A high-powered LED (light emitting diode), referred to as a first set of high-powered LEDs 140, having a heatsink 142 is mounted on the endcap 130 in alignment with the hollow space through the cylindrical column 126 and the base 116. Four additional high-powered LEDs, referred to as a second set of high-powered LEDs 144, having respective heatsinks 146 are mounted on the base 116 in positions evenly spaced around the hollow cylindrical column 126. A cylindrical collar 148 is bolted to the base 116 surrounding the second set high-powered LEDs 144. A lip 150 formed at the top of the cylindrical collar 148 reduces the size of a cylindrical opening within the cylindrical collar 148.

The hollow cylindrical column 126 forms in innermost barrier for confining light emitted from the first set of high-powered LED 140 within a cylindrical light pipe for illuminating a circular spot on a first diffuser segment (not shown) that is mounded within the hollow space at the top of the cylindrical column 126. The cylindrical collar 148 forms an immediately surrounding barrier that confines light emitted from the second set of high-powered LEDs 144 within an annular space between the cylindrical column 126 and the cylindrical collar 148 for illuminating an annular spot on a second diffuser segment (not shown) that overlies the cylindrical collar 148. The second diffuser segment can be mounted on a seat 152 recessed within the upright sleeve 118 and extends to a seat 154 recessed in the periphery the hollow cylindrical column 126 in the same plane as the first diffuser segment.

By energizing the single high-powered LED comprising the first set of LEDs 140 without energizing the second set of LEDs 144, the circular spot on the first diffuser can be illuminated without illuminating any of the surrounding second diffuser segment. Similarly, the second set of LEDs 144 can be energized without energizing the first set of LEDs 140 for illuminating the annular spot on the second diffuser segment without illuminating any of the first diffuser segment or any of the second diffuser segment beyond the innermost portion of the lip 150 at the top of the cylindrical collar 148. Together, the first and second sets of LEDs 140 and 144 can be energized for illuminating a larger circular spot combining the areas of the first and second diffuser segments that can be separately illuminated.

The first set of LEDs 140 is spaced at a distance from the first diffuser segment so that the divergence of light from the first set of LEDs 140 at least partially overfills a first size circular aperture delimited by the cylindrical column 126 for evenly illuminating the circular spot on the first diffuser segment and for defining the outer reaches of a smaller aperture stop of the illumination system. Similarly, the number, placement, divergence angle, and spacing of the LEDs within the second set of LEDs 144 are set to at least partially overfill an annular aperture delimited by both the cylindrical column 126 and the cylindrical collar 148 for evenly illuminating the annular spot on the second diffuser segment. Energizing both the first and second sets of LEDs 140 and 144 has the effect of overfilling a second size circular aperture delimited by the lip 150 of the cylindrical collar 148 for illuminating a larger circular spot combining the circular spot on the first diffuser segment with the annular spot on the second diffuser segment and for defining the outer reaches of a larger aperture stop of the illumination system.

The common diffuser plane is preferably located at the front focal plane of the collimating lens 104 and the illuminated portions of the diffuser segments emit light from individual points through range of angles that preferably fill a substantial portion of the aperture of the collimating lens 104. The light from each point on the illuminated diffuser segments is refracted by the collimating lens 104 as a collimated beam having a width capable of filling the intended field of view above the mounting stage and having a unique orientation to the common optical axis of the imaging and illumination systems in accordance with the radial and azimuthal positions of the point in the diffuser plane. The two different size circular apertures supported by the substage illuminator 108 can provide for illuminating the test object through two different angular ranges and can be conjugately matched in size to the aperture sizes of the imaging system at two different settings.

A number of features of the substage illuminator 108 are designed to accommodate the sizes of the LEDs within the first and second sets of LEDs 140 and 144, which in particular includes the size of the heatsinks 142 and 146 on which the individual LEDs are mounted. Thus, other more simplified constructions are possible using smaller LEDs or larger aperture sizes.

While the above description references certain embodiments in detail, variations and substitutions can be made consistent with the overall teachings provided. For example, although various barriers defining aperture stops is a substage illuminator are described as cylindrical structures, the barriers could also be formed as conical structures or have shapes that depart from axial symmetry to match the shape of apertures in an imaging system. Although a diffuser is presented as a preferred form of homogenizer, other forms of homogenizers common in the art can be used with an output face in the plane of the illuminator aperture stops. It will also be understood that variants of these embodiments and other features and functions and alternatives thereof may be combined into many other different systems or applications. As such, various presently unforeseen or unanticipated alternatives, modifications, variations or improvements therein may be subsequently made by those skilled in the art, which are also intended to be encompassed by the following claims.

1. An optical inspection system for capturing images of backlit test objects on a detector at two or more settings, comprising:
a telecentric imaging system having a first setting associated with a first size aperture stop and a second setting associated with a second larger size aperture stop;
a mounting stage for supporting a test object;
an illumination system having a substage illuminator and a collimating lens for directing light generated by the substage illuminator through the mounting stage to the telecentric imaging system along a common optical axis with the telecentric imaging system;
the substage illuminator having (a) a first set of one or more light sources surrounded by a first barrier that extends in height along the optical axis and defines a first size aperture stop of the illumination system and (b) a second set of one or more light sources located beyond the first barrier and surrounded by a second barrier that extends in height along the optical axis and defines a second larger size aperture stop of the illumination system; and
the illumination system being related to the telecentric imaging system so that the first size aperture stop of the illumination system images to the first size aperture stop of the telecentric imaging system at the first setting and the second larger size aperture stop of the illumination system images to the second larger size aperture stop of the telecentric imaging system at the second setting.

2. The optical inspection system of claim 1 in which the first and second size aperture stops of the illumination system are located proximate to a back focal plane of the collimating lens.

3. The optical inspection system of claim 2 in which the first setting of the telecentric imaging system is associated with a first front-end lens for directing light collected from the illumination system over a first range of angles through the first size aperture stop, and the second setting of the telecentric imaging system is associated with a second front-end lens for directing light collected from the illumination system over a second larger range of angles through the second larger size aperture stop.

4. The optical inspection system of claim 3 in which the first front-end lens of the telecentric imaging system together with the collimating lens of the illumination system is arranged for imaging the first size aperture stop of the illumination system to the first size aperture stop of the telecentric imaging system at the first setting, and the second front-end lens of the telecentric imaging system together with the collimating lens of the illumination system is arranged for imaging the second larger size aperture stop of the illumination system to the second larger size aperture stop of the telecentric imaging system at the second setting.

5. The optical inspection system of claim 1 in which the first set of one or more light sources provide for illuminating a first homogenizer segment within the first size aperture stop of the illumination system and the second set of one or more light sources provide for illuminating a second homogenizer segment within the second larger size aperture stop of the illumination system.

6. The optical inspection system of claim 5 in which the first barrier is a hollow cylindrical column and the second barrier is a cylindrical collar, and the second set of one or more light sources is located between the hollow cylindrical column and the cylindrical collar.

7. The optical inspection system of claim 6 in which the first homogenizer segment has a circular shape and is located within the hollow cylindrical column and the second homogenizer segment has an annular shape and is located between the hollow cylindrical column and the cylindrical collar.

8. The optical inspection system of claim 1 in which the telecentric imaging system includes a first lens grouping for imaging the test object at the first setting and includes a second lens grouping for imaging the test object at the second setting.

9. The optical inspection system of claim 1 in which:
the telecentric imaging system has a third setting associated with a third yet larger size aperture stop of the telecentric imaging system that is larger than the second size aperture stop of the telecentric imaging system,
the substage illuminator has a third set of one or more light sources surrounded by a third barrier that extends in height along the optical axis and defines a third size aperture stop of the illumination system that is yet larger than the second size aperture stop of the illumination system, and
the illumination system is further related to the telecentric imaging system so that the third yet larger size aperture stop of the illumination system images to the third yet larger size aperture stop of the telecentric imaging system at the third setting.
